(19) United States
(12) Patent Application Publication
(10) Pub. No.: US 2026/0332333 A1
(43) Pub. Date: Oct. 22, 2026

(54) SOUNDING REFERENCE SIGNAL AND CHANNEL STATE INFORMATION REPORT TRIGGERING

(71) Applicant: Lenovo (United States) Inc., Morrisville, NC (US)

(72) Inventors: Khaled Nafez Rauf Ardah, Ilmenau (DE); Seyedomid Taghizadeh Motlagh, Oberursel (DE); Mahdi Barzegar Khalilsarai, Berlin (DE); Hedieh Ajam, Nürnberg (DE)

(73) Assignee: Lenovo (United States) Inc., Morrisville, NC (US)

(21) Appl. No.: 19/299,804

(22) Filed: Aug. 14, 2025

(51) Int. Cl. H04L 5/00; H04W 74/0833

(52) U.S. Cl. CPC H04L 5/0048; H04W 74/0833

(57) ABSTRACT

Various aspects of the present disclosure relate to sounding reference signal (SRS) and channel state information (CSI) report triggering. A UE receives a first signal including an indication that a second signal includes one or more resource configurations for SRSs or CSI reference signals (CSI-RSs), or one or more report configurations for CSI reporting, receives, as part of a random access (RA) procedure and based on transmission of a first message including an RA preamble, a second message including at least a set of uplink resources, transmits, as part of the RA procedure, a third message using the set of uplink resources, and receives, based on the third message, a fourth message triggering an SRS resource or a CSI report configuration.

### TECHNICAL FIELD

The present disclosure relates to wireless communications, and more specifically to sounding reference signal (SRS) and channel state information (CSI) report triggering.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements. The device (e.g., NE or UE), processors, and methods of the present disclosure each have several innovative aspects, no single of which is solely responsible for the desirable features disclosed herein.

A UE for wireless communication is described. The UE may be configured to, capable of, or operable to perform one or more operations as described herein. For example, the UE may be configured to, capable of, or operable to receive a first signal including an indication that a second signal includes one or more resource configurations for SRSs or CSI reference signals (CSI-RSs), or one or more report configurations for CSI reporting, receive, as part of a random access (RA) procedure and based on transmission of a first message including an RA preamble, a second message including at least a set of uplink resources, transmit, as part of the RA procedure, a third message using the set of uplink resources, and receive, based on the third message, a fourth message triggering an SRS resource or a CSI report configuration.

A processor (e.g., a standalone processor chipset, or a component of the UE) for wireless communication is described. The processor may be configured to, capable of, or operable to perform one or more operations as described herein. For example, the processor may be configured to, capable of, or operable to receive a first signal including an indication that a second signal includes one or more resource configurations for SRSs or CSI-RSs, or one or more report configurations for CSI reporting, receive, as part of an RA procedure and based on transmission of a first message including an RA preamble, a second message including at least a set of uplink resources, transmit, as part of the RA procedure, a third message using the set of uplink resources, and receive, based on the third message, a fourth message triggering an SRS resource or a CSI report configuration.

A method performed or performable by a UE for wireless communication is described. The method may include receiving a first signal including an indication that a second signal includes one or more resource configurations for SRSs or CSI-RSs, or one or more report configurations for CSI reporting, receiving, as part of an RA procedure and based on transmission of a first message including an RA preamble, a second message including at least a set of uplink resources, transmitting, as part of the RA procedure, a third message using the set of uplink resources, and receiving, based on the third message, a fourth message triggering an SRS resource or a CSI report configuration.

In some implementations, the UE, the processor, and the method may further be configured to, capable of, or operable to receive the second signal including the one or more resource configurations or the one or more report configurations. In some implementations, the second message further includes a request for the UE to transmit a capability report indicating a capability of the UE to support the one or more resource configurations or the one or more report configurations. In some implementations, the third message includes the capability report.

In some implementations, the capability report includes an indication of one or more SRS resources, one or more CSI-RS resources, or one or more CSI report configurations supported by the UE. In some implementations, the fourth message includes a physical downlink shared channel (PDSCH) transmission or a downlink control information (DCI) signal scheduling the PDSCH transmission.

In some implementations, the fourth message includes an indication of one or more SRS resources, one or more CSI-RS resources, or one or more CSI report configurations, and where the one or more SRS resources, the one or more CSI-RS resources, or the one or more CSI report configurations are based on a capability of the UE. In some implementations, the first message further includes a request for the second signal. In some implementations, the first signal includes an system information (SI) block 1 (SIB1).

An NE (e.g., a base station) for wireless communication is described. The NE may be configured to, capable of, or operable to perform one or more operations as described herein. For example, the NE may be configured to, capable of, or operable to transmit a first signal including an indication that a second signal includes one or more resource configurations for SRSs or CSI-RSs, or one or more report configurations for CSI reporting, transmit, as part of an RA procedure and based on reception of a first message including an RA preamble, a second message including at least a set of uplink resources, receive, as part of the RA procedure, a third message using the set of uplink resources, and transmit, based on the third message, a fourth message triggering an SRS resource or a CSI report configuration.

A processor (e.g., a standalone processor chipset, or a component of an NE) for wireless communication is described. The processor may be configured to, capable of, or operable to perform one or more operations as described herein. For example, the processor may be configured to, capable of, or operable to transmit a first signal including an indication that a second signal includes one or more resource configurations for SRSs or CSI-RSs, or one or more report configurations for CSI reporting, transmit, as part of an RA procedure and based on reception of a first message including an RA preamble, a second message including at least a set of uplink resources, receive, as part of the RA procedure, a third message using the set of uplink resources, and transmit, based on the third message, a fourth message triggering an SRS resource or a CSI report configuration.

A method performed or performable by an NE (e.g., a base station) for wireless communication is described. The method may include transmitting a first signal including an indication that a second signal includes one or more resource configurations for SRSs or CSI-RSs, or one or more report configurations for CSI reporting, transmitting, as part of an RA procedure and based on reception of a first message including an RA preamble, a second message including at least a set of uplink resources, receiving, as part of the RA procedure, a third message using the set of uplink resources, and transmitting, based on the third message, a fourth message triggering an SRS resource or a CSI report configuration.

In some implementations, the NE, the processor, and the method may further be configured to, capable of, or operable to transmit the second signal including the one or more resource configurations or the one or more report configurations. In some implementations, the second message further includes a request for a UE to transmit a capability report indicating a capability of the UE to support the one or more resource configurations or the one or more report configurations. In some implementations, the third message includes the capability report.

In some implementations, the capability report includes an indication of one or more SRS resources, one or more CSI-RS resources, or one or more CSI report configurations supported by the UE. In some implementations, the fourth message includes a PDSCH transmission or a DCI signal scheduling the PDSCH transmission.

In some implementations, the fourth message includes an indication of one or more SRS resources, one or more CSI-RS resources, or one or more CSI report configurations, and where the one or more SRS resources, the one or more CSI-RS resources, or the one or more CSI report configurations are based on a capability of a UE. In some implementations, the first message further includes a request for the second signal. In some implementations, the first signal includes a SIB1.

### BRIEF DESCRIPTION OF THE DRAWINGS

FIG. 1 illustrates an example of a wireless communications system in accordance with aspects of the present disclosure.

FIG. 2 illustrates an example of a wireless communications system in accordance with aspects of the present disclosure.

FIG. 3 illustrates an example of a process flow in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates an example of a flowchart of a method performed by a UE in accordance with aspects of the present disclosure.

FIG. 8 illustrates an example of a flowchart of a method performed by an NE in accordance with aspects of the present disclosure.

### DETAILED DESCRIPTION

A UE may perform an RA procedure to connect with an NE. Once the UE transitions from an inactive/idle mode to a connected mode via the RA procedure, the UE may be configured to transmit SRSs and/or CSI reports which may improve communication between the UE and the NE. During the RA procedure, the UE does not trigger SRSs or CSI reports which results in a low downlink throughput at the UE during the RA procedure or immediately after the RA procedure. Thus, it may be beneficial for the UE and the NE to support early SRS or CSI report triggering. Early SRS or CSI reporting triggering may refer to the triggering of an SRS or a CSI report during the RA procedure or prior to the UE transitioning to the connected mode via the RA procedure.

The methods described herein support early SRS or CSI report triggering. A UE may receive, from an NE and prior to an RA procedure, a first signal including an indication that a second signal includes one or more resource configurations (e.g., for SRSs or CSI-RSs) or one or more report configurations (e.g., for CSI reporting). The UE may initiate the RA procedure and transmit a first message the includes an RA preamble to the NE. In response to the first message and as part of the RA procedure, the NE may transmit a second message that includes a set of uplink resource to the UE. Upon receiving the second message and as a part of the RA procedure, the UE may transmit a third message to the NE using the set of uplink resources. The NE may receive the third message and as part of the RA procedure, transmit a fourth message (e.g., DCI or PDSCH) to the UE that triggers an SRS resource and a CSI report configuration at the UE. It should be understood that various terms may be used interchangeably with “communicating,” such as “signaling,” “transmitting,” “receiving,” “outputting,” “forwarding,” “relaying,” “retrieving,” “obtaining,” and so forth.

By performing the techniques described, the wireless communications system provides early SRS or CSI report triggering during an RA procedure. Early SRS or CSI report triggering may allow the NE and the UE to derive CSI and perform link adaption with closed-loop precoding and increased MCS as well as time and frequency tracking during or immediately after the RA procedure.

Aspects of the present disclosure are described in the context of a wireless communications system. Additional aspects of the present disclosure are described in the context of component diagrams, process flows, method flows, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

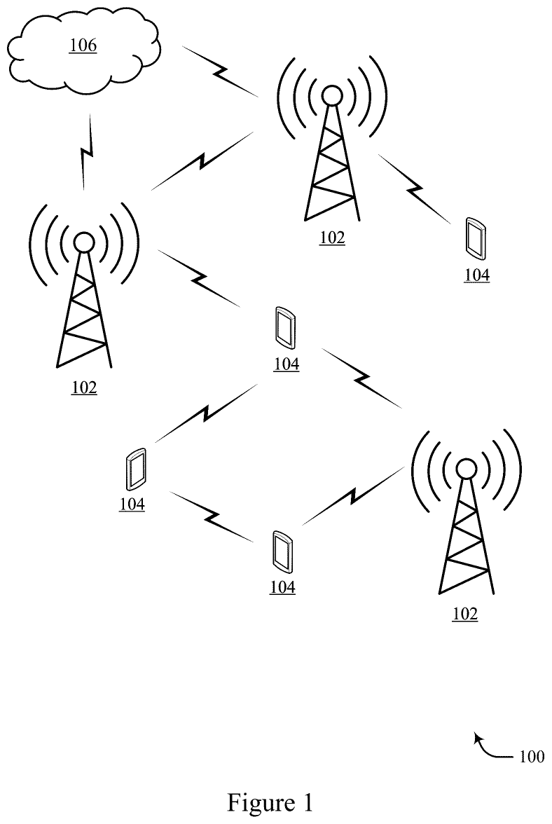

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the UE 104 may perform an RA procedure to connect with the NE 102. To initiate the RA procedure, the UE 104 may transmit Msg1 to the NE 102 using a physical RA channel (PRACH) during a PRACH occasion. Msg1 may include an RA preamble (e.g., an RA preamble selected by the UE 104 from a predefined set of RA preambles). Upon receiving Msg1, the NE 102 may transmit Msg2 to the UE 104. Msg2 may include one or more of a time advance (TA) command, an RA preamble ID (RAPID), an uplink grant (e.g., a set of physical uplink shared channel (PUSCH) resources), etc. In response to receiving Msg2, the UE 104 may transmit Msg3 to the NE 102 using the uplink grant provided in Msg2. Msg3 may carry some radio resources control (RRC) messages or physical data. After processing Msg3, the NE 102 may transmit Msg4 to the UE 104 for contention resolution. If contention is resolved, the UE 104 may connect and communicate with the NE 102. That is, using the RA procedure, the UE 104 may transition from an idle/inactive mode to a connected mode.

According to implementations, one or more of the NEs 102 and the UEs 104 are operable to implement various aspects of the techniques described with reference to the present disclosure. For example, a UE 104 receives a first signal including an indication that a second signal includes one or more resource configurations for SRSs or CSI-RSs, or one or more report configurations for CSI reporting, receives, as part of an RA procedure and based on transmission of a first message including an RA preamble, a second message including at least a set of uplink resources, transmits, as part of the RA procedure, a third message using the set of uplink resources, and receives, based on the third message, a fourth message triggering an SRS resource or a CSI report configuration. An NE 102 (e.g., a base station, gNB) transmits a first signal including an indication that a second signal includes one or more resource configurations for SRSs or CSI-RSs, or one or more report configurations for CSI reporting, transmits, as part of an RA procedure and based on reception of a first message including an RA preamble, a second message including at least a set of uplink resources, receives, as part of the RA procedure, a third message using the set of uplink resources, and transmits, based on the third message, a fourth message triggering an SRS resource or a CSI report configuration.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

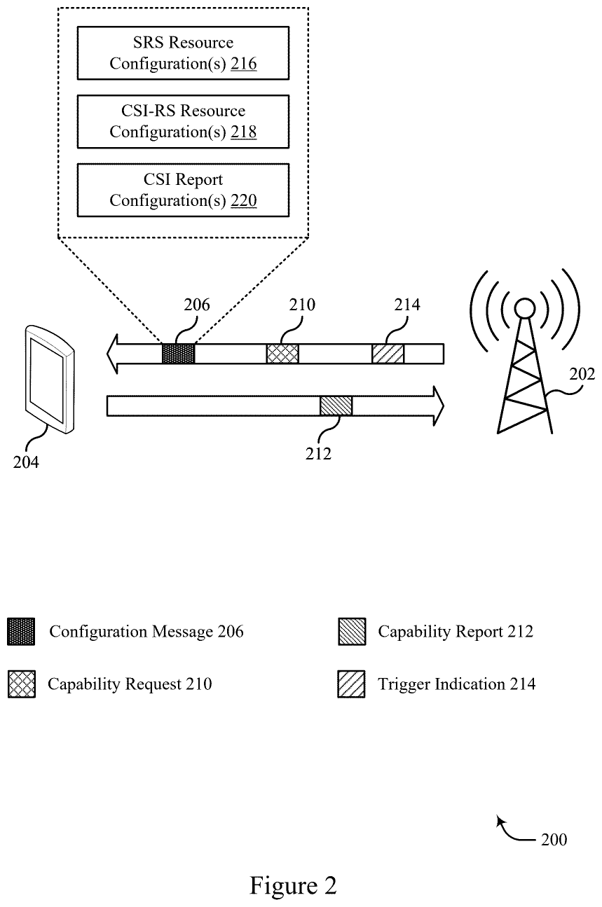

FIG. 2 illustrates an example of a wireless communications system 200 in accordance with aspects of the present disclosure. In some examples, the wireless communications system 200 may implement aspects of the wireless communications system 100. For example, the UE 204 and the NE 202 may be examples of the UE 104 and the NE 102, respectively, as described with reference to FIG. 1.

In some examples, the UE 204 may receive a configuration message 206 from the NE 202 prior to or during an RA procedure. The configuration message 206 may include one or more configurations that include one or more SRS resource configurations 216, one or more CSI-RS resource configurations 218, or one or more CSI report configurations 220. An SRS resource configuration 216 may indicate a set of candidate resources for SRS transmissions. A CSI-RS resource configuration 218 may indicate a set of candidate resources for CSI-RS receptions. A CSI report configuration 220 may indicate metrics to measure and include in a CSI report. Such metrics may include a channel quality indicator (CQI), a precoding matrix indicator (PMI), a reference signal received power (RSRP) value, a received signal strength indicator (RSSI) value, a signal-to-interference-plus-noise ratio (SINR) value, etc. Further, the CSI report configuration 220 may indicate a set of candidate resources for CSI report transmission.

In some examples, the configuration message 206 may be signaled to the UE 204 using SI signaling. For example, the configuration message 206 may be included in a SIB1. Additionally, or alternatively, the configuration message 206 may be included in SI signaling dedicated to early SRS, CSI-RS, or CSI report triggering (e.g., SRS, CSI-RS, or CSI report triggering that occurs during the RA procedure). In yet another example, the configuration message 206 may be included in on-demand SI signaling that is sent to the UE 204 upon receiving a request from the UE 204.

In some examples, the NE 202 may indicate an existence of the configuration message 206 within the SI signaling to the UE 204. For example, the existence of the configuration message 206 may be signaled to the UE 204 via the SIB1. The SIB1 may include single bit whose logic value indicates the existence of the configuration message 206 within the SI signaling (e.g., the SIB1, the dedicated SI signaling, or the on-demand SI signaling). A logic value of one may indicate the existence of the configuration message 206 within the SI signaling, whereas a logic value of zero may indicate that the configuration message 206 is not included within the SI signaling, or vice versa. If the NE 202 indicates that the configuration message 206 is not within the SI signaling, the UE 204 may determine that the NE 202 does not support early SRS, CSI-RS, or CSI report triggering. If the UE 204 determines that the NE 202 does not support early SRS, CSI-RS, or CSI report triggering, the UE 204 may not perform an RA procedure with the NE 202 and may select another NE 202 to connect to.

Alternatively, the UE 204 may determine that the NE 202 supports early SRS, CSI-RS, or CSI report triggering (e.g., based on the NE 202 indicating an existence of the configuration message 206 within the SI signaling) and perform the RA procedure with the NE 202. To initiate the RA procedure, the UE 204 may transmit Msg1 to the NE 202 that includes a selected RA preamble during a selected PRACH occasion. In some examples, the UE 204 may utilize Msg1 to indicate to the NE 202 that the UE 204 supports early SRS, CSI-RS, or CSI report triggering. For example, the UE 204 may select an RA preamble or a PRACH occasion that implicitly indicates to the NE 202 that the UE 204 supports early SRS, CSI-RS, or CSI report triggering. Alternatively, or additionally, the UE 204 may utilize Msg1 to request the configuration message 206 from the NE 202. For example, the UE 204 may select an RA preamble or a PRACH occasion that implicitly requests the configuration message 206. In response to Msg1, the NE 202 may transmit the configuration message 206 to the UE 204 (e.g., via the on-demand SI signaling).

Upon receiving Msg1, the NE 202 may transmit Msg2 to the UE 204. In some examples, Msg2 may include one or more of a set of uplink resources (e.g., a set of PUSCH resources) or a capability request 210. The capability request 210 may include a single bit indication where a logic value of the single bit indicates whether the UE 204 triggers transmission of a capability report 212. A logic value of one may indicate triggering of the capability report 212, whereas a logic value of zero may indicate no triggering of the capability report 212, or vice versa. If UE 204 does not receive the capability request 210, the UE 204 may assume no triggering of the capability report 212 (or a logic value of zero). Alternatively, the capability request 210 may include a multi-bit indication. Each bit of the multi-bit indication may be mapped to a codepoint associated with a respective capability report 212. The respective capability report 212 may be triggered dependent on a logic value of the associated bit. In some examples, the capability request 210 may trigger one or multiple capability reports 212.

In response to Msg2, the UE 204 may transmit Msg3 to the NE 202 using the set of uplink resources indicated in Msg2. In some examples, Msg3 may include the capability report(s) 212 triggered by Msg2. A capability report 212 may include UE capability information related to early SRS, CSI-RS, or CSI report triggering. In some examples, the UE 204 may identify that the capabilities of the UE 204 are not compatible with the configurations included in the configuration message 206 (e.g., due to limited resources at the UE 204) and therefore, the UE 204 is unable to support early SRS, CSI-RS, or CSI report triggering. In such case, the capability report 212 may include a single bit that indicates that UE 204 is unable to support early SRS, CSI-RS, or CSI report triggering. Alternatively, the UE 204 may indicate that the UE 204 is unable to support early SRS, CSI-RS, or CSI report triggering by refraining from transmitting the capability report 212 or transmitting an empty or all-zero capability report 212. If the UE 204 is unable to support early SRS, CSI-RS, or CSI report triggering due to limited capabilities, the UE 204 may pull out of early SRS, CSI-RS, or CSI report triggering.

Alternatively, the UE 204 may identify that the capabilities of the UE 204 are compatible with the configurations included in the configuration message 206 and therefore, the UE 204 may support early SRS, CSI-RS, or CSI report triggering. In such case, the capability report 212 may include a single bit that indicates that UE 204 is able to support early SRS, CSI-RS, or CSI report triggering. Additionally, or alternatively, the capability report 212 may include an indication of a compatible SRS resource, a compatible CSI-RS resource, or a compatible CSI report configuration 220. The compatible SRS resource, the compatible CSI-RS resource, or the compatible CSI report configuration may be selected from the set of candidate resources for CSI-RS reception indicated in the CSI-RS resource configuration 218, the set of candidate resources for SRS transmission indicated in the SRS resource configuration 216, or the one or more candidate CSI report configurations 220, respectively. In some examples, the capability report 212 may include an indication of a recommended resource index that is associated with the compatible SRS resources or the compatible CSI-RS resource. Alternatively, the capability report 212 may include a set of codepoints, where each codepoint is associated with a respective resource index and indicates whether a resource (e.g., CSI-RS resource or SRS resource) corresponding to the respective resource index is compatible with the capabilities of the UE 204.

In response to Msg3, the NE 202 may transmit DCI scheduling Msg4 (e.g., a PDSCH reception). In some examples, the DCI or Msg4 may include a trigger indication 214. In some examples, the trigger indication 214 may trigger (or activate) one or more SRS resources, one or more CSI-RS resource, or one or more CSI report configurations at the UE 204. In some examples, the one or more triggered resources or the one or more triggered CSI report configurations may include the compatible SRS resource, the compatible CSI-RS resource, or the compatible CSI report configuration indicated in the capability report 212.

Alternatively, the one or more triggered resources may be different from those indicated in the capability report 212. As an example, the UE 204 and the NE 202 may determine a triggered resource based on a recommended resource indicated in the capability report 212 and a shift (e.g., an offset in time or frequency). The UE 204 and the NE 202 may determine the shift based on one or more UE-specific parameters (e.g., PRACH occasion or PRACH sequence). For example, if the UE 204 selects a PRACH occasion of index i for transmission of Msg1, the UE 204 and the NE 202 may determine that the triggered resource is one of the recommended resources indicated in the capability report 212 with a time or frequency shift corresponding to the index i (e.g., a shift of 1 symbol, 1 slot, 1 resource element (RE), or 1 resource block (RB)). The UE 204 and the NE 202 may determine the shift by referencing a table that indicates mappings between PRACH indexes and shifts. In some examples, the UE 204 may indicate the shift to the NE 202 via Msg3. Alternatively, the UE 204 may receive the shift from the NE 202 via Msg4. The shift may indicate a starting RB or symbol of a configured SRS resource, CSI-RS resource, of CSI-RS reporting resource.

In some examples, the trigger indication 214 may include multiple CSI sub-report configurations that each indicate respective measurement metrics for CSI reporting. For example, the trigger indication 214 may include at least a first CSI sub-report configuration for early CSI reporting and a second CSI sub-report configuration for subsequent CSI reporting. The UE 204 may utilize the first CSI sub-report configuration for CSI reporting that occurs during the RA procedure and prior to the UE 204 transitioning to the connected mode and the UE 204 may utilize the second CSI sub-reporting configuration for CSI reporting that occurs after the UE 204 transitions to the connected mode. As an example, the first CSI sub-report configuration may configure the UE 204 to report wideband-based CSI reports, whereas the second CSI sub-report configuration may configure the UE 204 to report subband-based CSI reports.

Additionally, or alternatively, the trigger indication 214 may include multiple subsets of SRS resources. For example, the trigger indication 214 may include at least a first subset of SRS resources for early SRS transmissions and a second subset of SRS resources for subsequent SRS transmissions. The UE 204 may utilize the first subset of SRS resources for SRS transmissions that occur during the RA procedure and prior to the UE 204 transitioning to the connected mode and the UE 204 may utilize the second subset of SRS resources for SRS transmissions that occur after the UE 204 transitions to the connected mode. As an example, the UE 204 may be configured with first partial SRS antenna switching resources for early SRS transmissions and the UE 204 may be configured with second partial SRS antenna switching resources for subsequent SRS transmissions. In some examples, the multiple subsets of SRS resources may be partially overlapping or completely non-overlapping with respect to one another.

In some examples, the trigger indication 214 may include an indication of SRS resources, CSI-RS resources, or a CSI report configuration for early SRS, CSI-RS, or CSI reporting and at a later time (e.g., after the UE 204 transitions to the connected mode), the UE 204 may receive another trigger indication 214 that includes an indication of new SRS resources, new CSI-RS resources, or a new CSI-report configuration for subsequent SRS, CSI-RS, or CSI reporting.

After receiving the trigger indication 214 (e.g., via the DCI or Msg4), the UE 204 may transmit one or more SRSs via the triggered SRS resources. Additionally, or alternatively, the UE 204 may receive one or more CSI-RSs via the triggered CSI-RS resources and perform measurements on the one or more CSI-RSs. Additionally, or alternatively, the UE 204 may transmit a CSI-RS report via a set of CSI report resources. In some examples, the set of CSI report resources are configured via the SI signal or scheduled via the Msg3, the DCI, or Msg4. The CSI report may include one or more of the measurements of the one or more CSI-RSs (e.g., RSRP, SINR, or RSSI) or one or more resources indexes of the triggered CSI-RS resources (e.g., N largest resource).

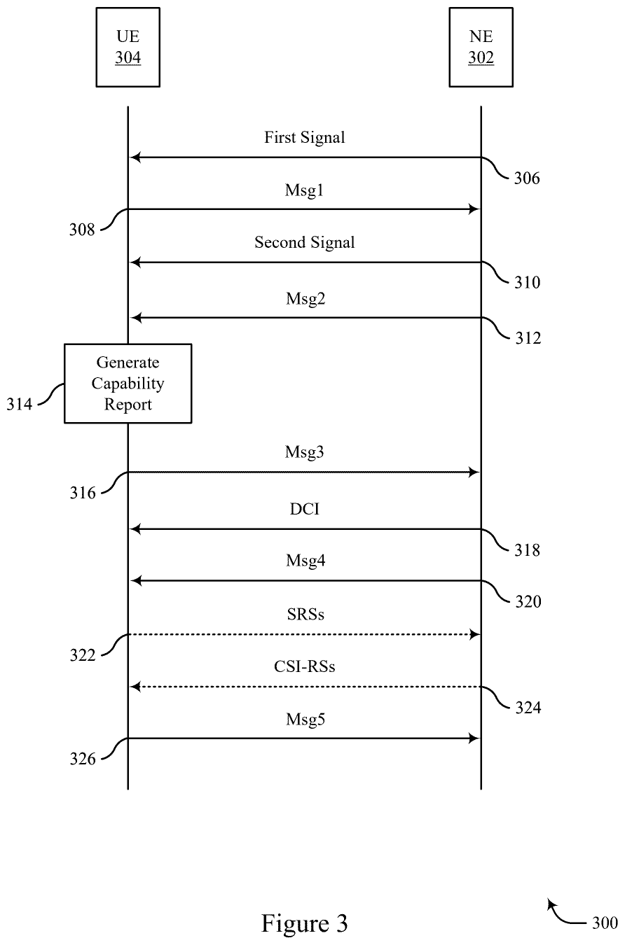

FIG. 3 illustrates an example of a process flow 300 in accordance with aspects of the present disclosure. In some examples, the process flow 300 may implement or be implemented by aspects of the wireless communications system 100 or the wireless communications system 200. For example, the process flow 300 may be implemented by the UE 104, the NE 102, the UE 204, or the NE 202 as described with reference to FIG. 1 or 2.

At 306, the NE 302 may communicate (e.g., transmit, signal, or send) a first signal including an indication that a second signal includes one or more resource configurations for SRSs or CSI-RSs, or one or more report configuration for CSI reporting. In some examples, the first signal may be a SIB1. At 308, the UE 304 may communicate (e.g., transmit, signal, or send) Msg1 as part of an RA procedure. In some examples, Msg1 may be transmitted during a selected PRACH occasion and may include a selected RA preamble. The selected RA preamble or the selected PRACH occasion may serve as implicit request for NE 302 to transmit the second signal to the UE 304.

At 310, the UE 304 may receive the second signal including the one or more resource configurations and the one or more CSI report configuration. In some examples, the NE 302 may communicate (e.g., transmit, signal, or send) the second signal in response to receiving the implicit request in Msg1. The second signal may be an SI signal dedicated to early SRS, CSI-RS, or CSI reporting or an on-demand SI signal.

At 312, the NE 302 may communicate (e.g., transmit, signal, or send) Msg2 as part of the RA procedure. In some examples, Msg2 may include a set of uplink resources and a request for the UE 304 to communicate (e.g., transmit, signal, or send) a capability report indicating a capability of the UE 304 to support the one or more resource configurations or the one or more report configurations.

At 314, the UE 304 may generate the capability report. The capability report may include an indication of one or more SRS resources, one or more CSI-RS resources, or one or more CSI report configurations supported by the UE 304. At 316, the UE 304 may communicate (e.g., transmit, signal, or send) Msg3 as a part of the RA procedure using the set of uplink resources. In some examples, Msg3 may include the capability report generated by the UE 304.

At 318, the NE 302 may communicate (e.g., transmit, signal, or send) DCI scheduling Msg4 (or a PDSCH transmission) and at 320, the NE 302 may communicate (e.g., transmit, signal, or send) Msg4 using resources indicated in the DCI. In some examples, the DCI or Msg4 may trigger an SRS resource or a CSI report configuration. As such, the DCI or Msg4 may include an indication of one or more SRS resources, one or more CSI-RS resources, or one or more CSI report configurations which are selected by the NE 302 based on the capability report.

At 322, the UE 304 may communicate (e.g., transmit, signal, or send) one or more SRSs using the one or more SRS resources indicated in DCI or Msg4. At 324, the UE 304 may receive one or more CSI-RSs using the one or more CSI-RS resources indicated in Msg4 or DCI and measure the received one or more CSI-RSs.

At 326, the UE 304 may communicate (e.g., transmit, signal, or send) Msg5. Msg5 may be a PUCCH transmission or a PUSCH transmission that includes a CSI report that is generated based on the one or more CSI report configurations indicated in the DCI or Msg 4 and includes the CSI-RS measurements.

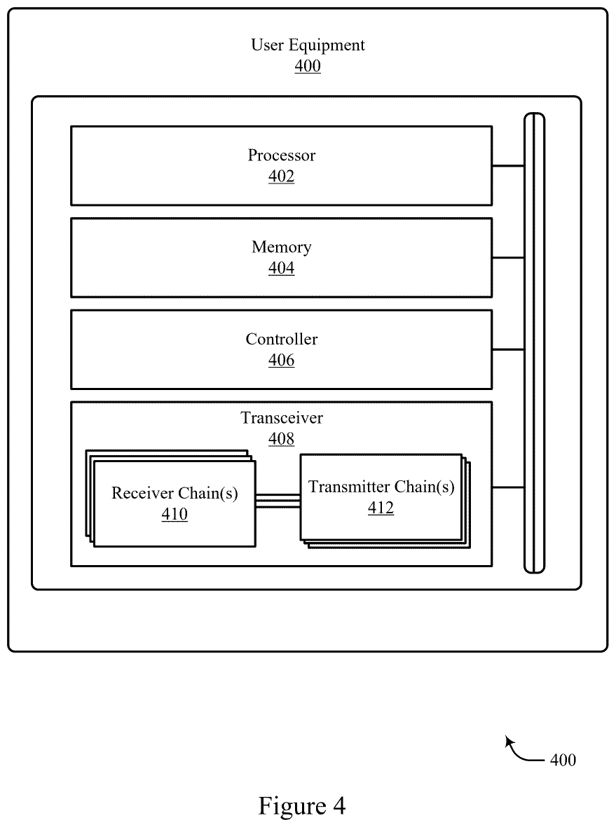

FIG. 4 illustrates an example of a UE 400 in accordance with aspects of the present disclosure. In some examples, the UE 400 may be an example of a UE as described with reference to FIGS. 1 through 4. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving a first signal including an indication that a second signal includes one or more resource configurations for SRSs or CSI-RSs, or one or more report configurations for CSI reporting, receiving, as part of an RA procedure and based on transmission of a first message including an RA preamble, a second message including at least a set of uplink resources, transmitting, as part of the RA procedure, a third message using the set of uplink resources, and receiving, based on the third message, a fourth message triggering an SRS resource or a CSI report configuration.

Additionally, or alternatively, the UE 400 may support at least one memory (e.g., the memory 404) and at least one processor (e.g., the processor 402) coupled with the at least one memory and configured to cause the UE to receive a first signal including an indication that a second signal includes one or more resource configurations for SRSs or CSI-RSs, or one or more report configurations for CSI reporting, receive, as part of an RA procedure and based on transmission of a first message including an RA preamble, a second message including at least a set of uplink resources, transmit, as part of the RA procedure, a third message using the set of uplink resources, and receive, based on the third message, a fourth message triggering an SRS resource or a CSI report configuration. Additionally, the UE 400 may be configured to support any one or combination of the at least one processor configured to cause the UE 400 to receive the second signal including the one or more resource configurations or the one or more report configurations.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

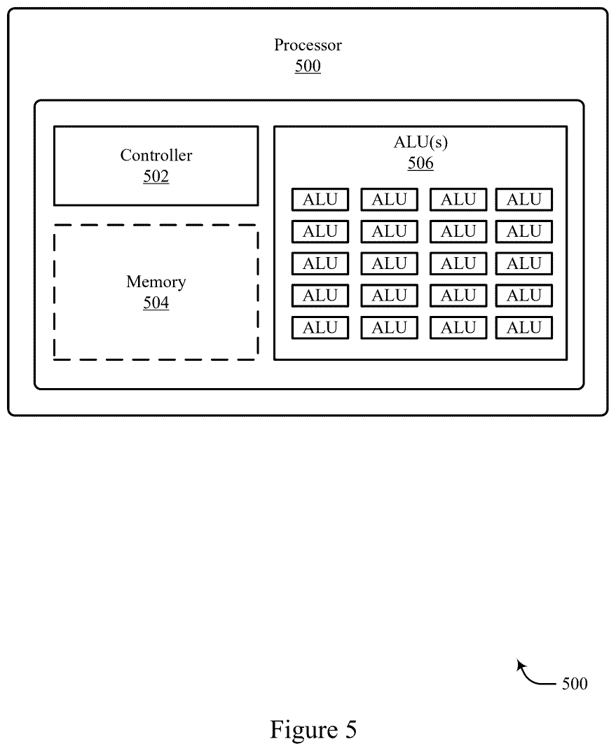

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., RA memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to receive a first signal including an indication that a second signal includes one or more resource configurations for SRSs or CSI-RSs, or one or more report configurations for CSI reporting, receive, as part of an RA procedure and based on transmission of a first message including an RA preamble, a second message including at least a set of uplink resources, transmit, as part of the RA procedure, a third message using the set of uplink resources, and receive, based on the third message, a fourth message triggering an SRS resource or a CSI report configuration. Additionally, the processor 500 may be configured to or operable to support any one or combination of receiving the second signal including the one or more resource configurations or the one or more report configurations.

Moreover, the processor 500 may be configured to or operable to support at least one controller (e.g., the controller 502) coupled with at least one memory (e.g., the memory 504) and configured to cause the processor to transmit a first signal including an indication that a second signal includes one or more resource configurations for SRSs or CSI-RSs, or one or more report configurations for CSI reporting, transmit, as part of an RA procedure and based on reception of a first message including an RA preamble, a second message including at least a set of uplink resources, receive, as part of the RA procedure, a third message using the set of uplink resources, and transmit, based on the third message, a fourth message triggering an SRS resource or a CSI report configuration. Additionally, the processor 500 may be configured to or operable to support any one or combination of transmitting the second signal including the one or more resource configurations or the one or more report configurations.

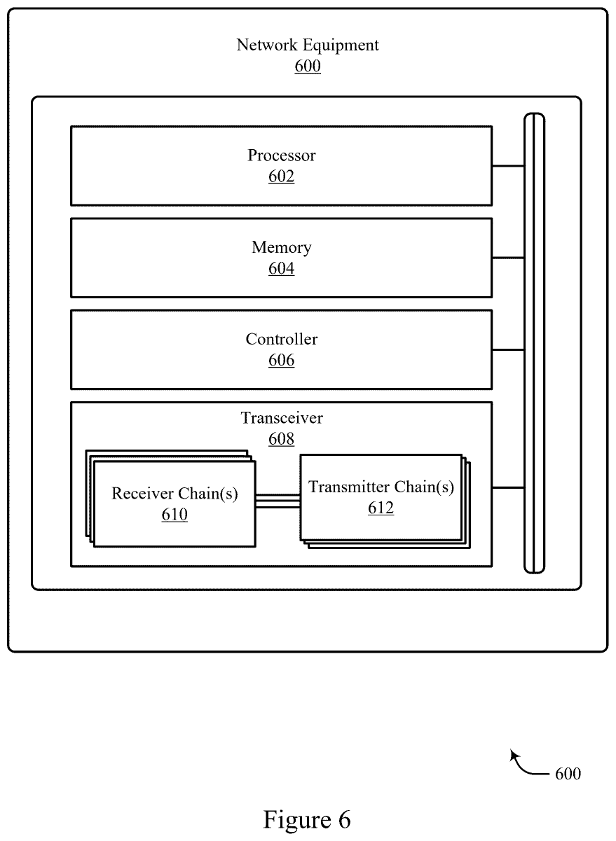

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for transmitting a first signal including an indication that a second signal includes one or more resource configurations for SRSs or CSI-RSs, or one or more report configurations for CSI reporting, transmitting, as part of an RA procedure and based on reception of a first message including an RA preamble, a second message including at least a set of uplink resources, receiving, as part of the RA procedure, a third message using the set of uplink resources, and transmitting, based on the third message, a fourth message triggering an SRS resource or a CSI report configuration.

Additionally, or alternatively, the NE 600 may support at least one memory (e.g., the memory 604) and at least one processor (e.g., the processor 602) coupled with the at least one memory and configured to cause the NE to transmit a first signal including an indication that a second signal includes one or more resource configurations for SRSs or CSI-RSs, or one or more report configurations for CSI reporting, transmit, as part of an RA procedure and based on reception of a first message including an RA preamble, a second message including at least a set of uplink resources, receive, as part of the RA procedure, a third message using the set of uplink resources, and transmit, based on the third message, a fourth message triggering an SRS resource or a CSI report configuration. Additionally, the NE 600 may be configured to support any one or combination of the at least one processor configured to cause the NE 600 to transmit the second signal including the one or more resource configurations or the one or more report configurations.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

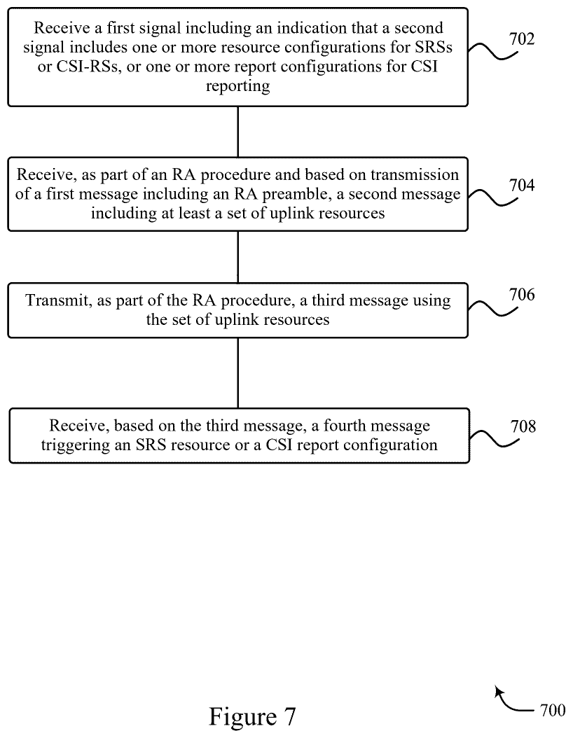

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include receiving a first signal including an indication that a second signal includes one or more resource configurations for SRSs or CSI-RSs, or one or more report configurations for CSI reporting. The operations of 702 may be performed in accordance with examples as described herein. In some implementations, aspects of the operations of 702 may be performed by the UE 400 as described with reference to FIG. 4.

At 704, the method may include receiving, as part of an RA procedure and based on transmission of a first message including an RA preamble, a second message including at least a set of uplink resources. The operations of 704 may be performed in accordance with examples as described herein. In some implementations, aspects of the operations of 704 may be performed by the UE 400 as described with reference to FIG. 4.

At 706, the method may include transmitting, as part of the RA procedure, a third message using the set of uplink resources. The operations of 706 may be performed in accordance with examples as described herein. In some implementations, aspects of the operations of 706 may be performed the UE 400 as described with reference to FIG. 4.

At 708, the method may include receiving, based on the third message, a fourth message triggering an SRS resource or a CSI report configuration. The operations of 708 may be performed in accordance with examples as described herein. In some implementations, aspects of the operations of 708 may be performed the UE 400 as described with reference to FIG. 4.

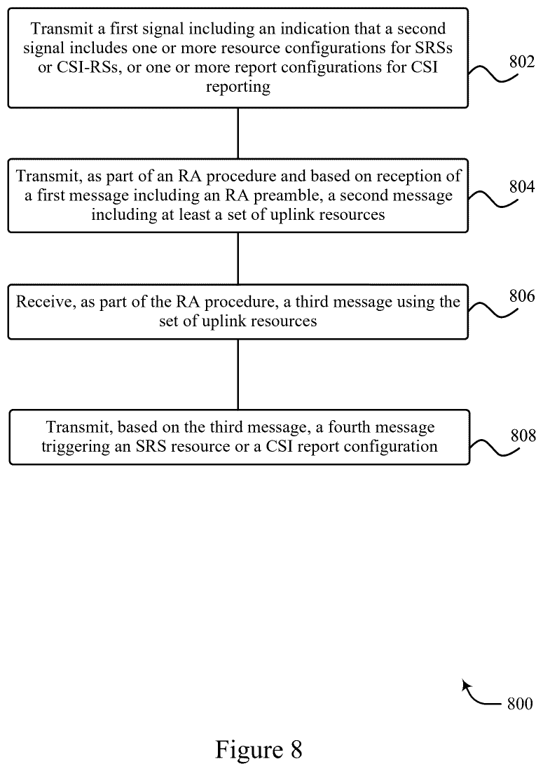

FIG. 8 illustrates a flowchart of a method 800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include transmitting a first signal including an indication that a second signal includes one or more resource configurations for SRSs or CSI-RSs, or one or more report configurations for CSI reporting. The operations of 802 may be performed in accordance with examples as described herein. In some implementations, aspects of the operations of 802 may be performed by the NE 600 as described with reference to FIG. 6.

At 804, the method may include transmitting, as part of an RA procedure and based on reception of a first message including an RA preamble, a second message including at least a set of uplink resources. The operations of 804 may be performed in accordance with examples as described herein. In some implementations, aspects of the operations of 804 may be performed by the NE 600 as described with reference to FIG. 6.

At 806, the method may include receiving, as part of the RA procedure, a third message using the set of uplink resources. The operations of 806 may be performed in accordance with examples as described herein. In some implementations, aspects of the operations of 806 may be performed by the NE 600 as described with reference to FIG. 6.

At 808, the method may include transmitting, based on the third message, a fourth message triggering an SRS resource or a CSI report configuration. The operations of 808 may be performed in accordance with examples as described herein. In some implementations, aspects of the operations of 808 may be performed by the NE 600 as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a first signal comprising an indication that a second signal comprises one or more resource configurations for sounding reference signals (SRSs) or channel state information reference signals (CSI-RSs), or one or more report configurations for CSI reporting;
receive, as part of a random access procedure and based at least in part on transmission of a first message comprising a random access preamble, a second message comprising at least a set of uplink resources;
transmit, as part of the random access procedure, a third message using the set of uplink resources; and
receive, based at least in part on the third message, a fourth message triggering an SRS resource or a CSI report configuration.

2. The UE of claim 1, wherein the at least one processor is further operable to cause the UE to:
receive the second signal comprising the one or more resource configurations or the one or more report configurations.

3. The UE of claim 1, wherein the second message further comprises a request for the UE to transmit a capability report indicating a capability of the UE to support the one or more resource configurations or the one or more report configurations.

4. The UE of claim 3, wherein the third message comprises the capability report.

5. The UE of claim 3, wherein the capability report comprises an indication of one or more SRS resources, one or more CSI-RS resources, or one or more CSI report configurations supported by the UE.

6. The UE of claim 1, wherein the fourth message comprises a physical downlink shared channel (PDSCH) transmission or a downlink control information (DCI) signal scheduling the PDSCH transmission.

7. The UE of claim 1, wherein the fourth message comprises an indication of one or more SRS resources, one or more CSI-RS resources, or one or more CSI report configurations, and wherein the one or more SRS resources, the one or more CSI-RS resources, or the one or more CSI report configurations are based at least in part on a capability of the UE.

8. The UE of claim 1, wherein the first message further comprises a request for the second signal.

9. The UE of claim 1, wherein the first signal comprises a system information block 1 (SIB1).

10. A network equipment (NE) for wireless communication, comprising:
at least one memory; and
at least one processor coupled with the at least one memory and operable to cause the NE to:
transmit a first signal comprising an indication that a second signal comprises one or more resource configurations for sounding reference signals (SRSs) or channel state information reference signals (CSI-RSs), or one or more report configurations for CSI reporting;
transmit, as part of a random access procedure and based at least in part on reception of a first message comprising a random access preamble, a second message comprising at least a set of uplink resources;
receive, as part of the random access procedure, a third message using the set of uplink resources; and
transmit, based at least in part on the third message, a fourth message triggering an SRS resource or a CSI report configuration.

11. The NE of claim 10, wherein the at least one processor is further operable to cause the NE to:
transmit the second signal comprising the one or more resource configurations or the one or more report configurations.

12. The NE of claim 10, wherein the second message further comprises a request for a user equipment (UE) to transmit a capability report indicating a capability of the UE to support the one or more resource configurations or the one or more report configurations.

13. The NE of claim 12, wherein the third message comprises the capability report.

14. The NE of claim 12, wherein the capability report comprises an indication of one or more SRS resources, one or more CSI-RS resources, or one or more CSI report configurations supported by the UE.

15. The NE of claim 10, wherein the fourth message comprises a physical downlink shared channel (PDSCH) transmission or a downlink control information (DCI) signal scheduling the PDSCH transmission.

16. The NE of claim 10, wherein the fourth message comprises an indication of one or more SRS resources, one or more CSI-RS resources, or one or more CSI report configurations, and wherein the one or more SRS resources, the one or more CSI-RS resources, or the one or more CSI report configurations are based at least in part on a capability of a user equipment (UE).

17. The NE of claim 10, wherein the first message further comprises a request for the second signal.

18. The NE of claim 10, wherein the first signal comprises a system information block 1 (SIB1).

19. A method performed by a user equipment (UE), the method comprising:
receiving a first signal comprising an indication that a second signal comprises one or more resource configurations for sounding reference signals (SRSs) or channel state information reference signals (CSI-RSs), or one or more report configurations for CSI reporting;
receiving, as part of a random access procedure and based at least in part on transmission of a first message comprising a random access preamble, a second message comprising at least a set of uplink resources;
transmitting, as part of the random access procedure, a third message using the set of uplink resources; and
receiving, based at least in part on the third message, a fourth message triggering an SRS resource or a CSI report configuration.

20. A method performed by a network equipment (NE), the method comprising:
transmitting a first signal comprising an indication that a second signal comprises one or more resource configurations for sounding reference signals (SRSs) or channel state information reference signals (CSI-RSs), or one or more report configurations for CSI reporting;
transmitting, as part of a random access procedure and based at least in part on reception of a first message comprising a random access preamble, a second message comprising at least a set of uplink resources;
receiving, as part of the random access procedure, a third message using the set of uplink resources; and
transmitting, based at least in part on the third message, a fourth message triggering an SRS resource or a CSI report configuration.
